(19) United States
(12) Patent Application Publication
(10) Pub. No.: US 2021/0187437 A1
(43) Pub. Date: Jun. 24, 2021

(54) SYSTEMS AND METHODS FOR SEQUESTERING CARBON DIOXIDE AND OTHER POLLUTANTS

(71) Applicant: Mississippi Lime Company, St.Louis, MO (US)

(72) Inventors: Martin L. Gran, Chesterfield, MO (US); Randy Griffard, St. Mary, MO (US)

(21) Appl. No.: 17/126,967

(22) Filed: Dec. 18, 2020

Related U.S. Application Data
(60) Provisional application No. 62/949,591, filed on Dec. 18, 2019.

(51) Int. Cl. B01D 53/14; B01D 53/62; B01D 53/78; B65G 5/00

(52) U.S. Cl. CPC B01D 53/1475; B01D 53/1493; B01D 53/62; B01D 53/78; B65G 5/00; B01D 2258/0233; B01D 2251/404; B01D 2251/602; B01D 2251/606; B01D 2257/504; B01D 2252/103

(57) ABSTRACT

Systems and methods for the effective sequestration of waste gases from an industrial process such as, but not limited to, one or more lime or cement kilns used in the production of quicklime. This system may be used in conjunction with one or more shafts to an existing or abandoned mine that includes water capable of removing various pollutants in the gas stream, including but not limited, to sulfur compounds, chlorine compounds, mercury compounds, and carbon dioxide. Such pollutants may be sequestered in the mine itself through the process of particulate formation when the gas stream reacts with the mine water.

### CROSS REFERENCE TO RELATED APPLICATIONS

This application claims benefit of U.S. Provisional Patent Application No. 62/949,591 filed Dec. 18, 2019. The entire disclosure of all the above documents is herein incorporated by reference.

### BACKGROUND OF THE INVENTION

### Field of the Invention

This disclosure relates to the field of sequestering carbon dioxide. More specifically to systems and methods to sequester carbon dioxide and other pollutants from kiln exhaust gas using materials readily available in a limestone mine.

### Description of the Related Art

Calcium oxide (CaO), which is commonly referred to as quicklime (or even just lime), is an incredibly useful compound with a storied history in a variety of industrial applications in all sorts of areas. These uses range from many years ago where calcium oxide was heated to produce stage lighting (where the term “lime light” comes from) and as a building mortar for stone structures, to more modern uses where calcium oxide is an essential component of building materials such as cement, concrete, and plaster.

Outside of the most common construction uses, quicklime is explosively reactive to water. As a result, it can be dangerous to be in close proximity to quicklime. In fact, quicklime is even believed to have been weaponized in the ancient world. However, quicklime's fast reaction time with certain chemicals also makes it very useful as a part of a large number of industrial chemical processes and operations such as gas scrubbing, biofuel refining, and rubber manufacture, where quicklime can be used to carry out a particular reaction quickly. In these types of processes, the quicklime is commonly used as a reactant or as a catalyst. Further, quicklime is typically used because it can be manufactured in a controlled manner that, in turn, allows for controlled, consistent, and fast reactions.

Calcium oxide is typically produced by thermally decomposing limestone or seashells, each of which contain sufficient levels of calcium carbonate (CaCO₃), which is also known as calcite. The thermal decomposition of calcium carbonate may also be referred to as a lime burning process or calcination. Calcination generally is performed in some form of lime kiln. There are a large number of different types of lime kiln designs available in modern calcium oxide production. Some designs are little changed from processes used hundreds of years ago, while others are of relatively modern design. While there are a huge number of different lime kilns, most industrial processes use one of only a relatively small number of different designs. The design of a given lime kiln is often selected based on desired output and available input, as certain types of lime kilns are better for producing calcium oxide with certain qualities and characteristics and/or for operating on certain kinds of limestone feedstocks.

Regardless of the design, lime kilns are generally focused on two main types of operation, rotary or vertical shaft, and utilize a continuous inflow of limestone (or other source material) and outflow of calcium oxide. The systems are traditionally characterized by providing a counter-current flow of solids and gases and usually utilize three stages of action in the lime burning process. The first stage is a preheating zone where the limestone and/or other source material is heated to a temperature generally above 800° C. (about 1450° F.), typically by exposure to escaping exhaust gases from actions later in the lime kiln. In the second stage, or calcining zone, the limestone is heated to above 900° C. (about 1650° F.), and commonly about 1000° C. (about 1830° F.), to cause the calcination. The resultant calcium oxide is then cooled at the third stage, which is a cooling zone to prepare the calcium oxide for removal from the kiln. The chemical formula for calcination process is:

CaCO₃(s)→CaO(s)+CO₂(g)

In theory (which is basically operation under idealized conditions), during the calcination process, the applied heat causes so great of a molecular activity in the atoms making up the molecules of calcium carbonate that the CO₃ ion is broken up. Carbon dioxide molecules subsequently escape as a gas, while the remaining oxygen atom becomes the appropriate part of the calcium oxide structure. Thus, the process of making calcium oxide produces carbon dioxide, an unwanted greenhouse gas. The production of such greenhouse gasses may contribute to undesirable climate change. Further, the process of milling and then burning limestone and/or other source material may also liberate carbon dioxide that has been sequestered in the limestone and/or source material.

Thus, the production of quicklime, as is true with a variety of industrial processes, may actually serve as a source for pollutants. Moreover, in a variety of different industrial processes, such as the production of lime, aluminum, steel, or other materials where significant heat is needed, the heat is often generated from the incineration of fuel, such as coal. The gas exiting these smelters and kilns often contain high concentrations of particulate matter, as well as the natural by-products of combustion processes, which are essentially the same as those produced from a power plant utilizing the same type of fuel. This includes, among other pollutants, additional carbon dioxide. In a lime kin, the gas will generally comprise lime and limestone particles, as well as ash particles from the fuel being burned, along with various gaseous pollutants including sulfur, nitrogen, carbon dioxide, and chlorine and mercury compounds.

The eventual exhausting of gas and other materials from lime kilns may serve as a source of environmental pollution, which pollution may be regulated by governmental or other regulating bodies. Such exhaust gas may come from the interior processes of the lime kiln, from the external heating processes of the lime kiln, from other sources, or from a mixture of these sources. Typically, exhaust gas including pollutants are eventually ejected or vented to the atmosphere in the form of an exhaust stream, for example, from a smokestack.

Pollution controls, typically promulgated and administrated by pollution regulators, often require pollution mediation. Such pollution mediation most often will include a measuring process or other process that assists in determining or estimating the amount of pollution being exhausted from a given lime kiln or related plant. Such measuring processes are typically conducted in real time during the operation of the lime kiln, although other time-delayed or sampling processes may be used. In any case, the pollution measuring process will typically take place at or near the portion of the lime kiln or plant where the exhaust gas stream is finally ejected or vented to the atmosphere, for example, near or in a smokestack.

Typically, lime kiln operators will take various steps to reduce the quantity of pollutants emitted from their lime kilns. Such steps may include using various types of exhaust gas scrubbers, which tend to remove particulate matter and pollutants from the exhaust gas stream. In some cases, filter bags may be used to both collect particles and potentially treat gasses and particles as they interact with the bags. In any case, the pathway or ducting of the exhaust gas stream may be an efficient place to perform various pollution reduction processes to reduce the ultimate emission of pollutants. Although these pollutant-reducing processes may be quite effective (typically there are a range of processes available that vary in their effectiveness and related costs), each process has its own costs. Such costs may include the costs of maintaining the process and its necessary apparatuses, of providing raw materials, and of reductions in overall process efficiency, amongst others. Accordingly, time kiln operators must weigh the costs of their emission of pollutants against the costs of reducing those emissions.

Lime kilns (and other industrial processes for mined products) are often co-located with corresponding mines in order to simplify processing and transporting the materials for production. In the case of a plant producing quicklime, the underlying mine is generally a mine for limestone and the mine has rarely had all the limestone removed therefrom.

While limestone is commonly obtained from a quarry, the underground mining of limestone may be both economical and necessary in certain areas. This may be for a variety of reasons including regulatory ones and those related to the economy of removing overlaying rock in order to quarry. Underground limestone mines will generally comprise a “room and pillar” construction to provide for sufficient roof support and stability. Thus, an operational mine will often have large unused portions where most or all economical limestone has been removed and miners have moved on to a different area.

In many cases, these mines will continuously fill with water from seepage, springs, and other water sources. Where necessary, a mine will pump out the water as it accumulates in the mine. However, the operators of a given mine may allow areas that are unused and previously mined to accumulate water, sometimes significant amounts of water. Such significant amounts of water may form an underground lake. The water in such a mine is typically at least slightly alkaline in nature. This alkalinity is due, at least in part, to the dissolution of calcium carbonate into the water. Further, the temperature in a mine is typically a consistent 55° F., which temperature may allow for a relatively higher alkaline saturation in the water than at room temperature.

### SUMMARY OF THE INVENTION

The following is a summary of the invention in order to provide a basic understanding of some aspects of the invention. This summary is not intended to identify key or critical elements of the invention or to delineate the scope of the invention. The sole purpose of this section is to present some concepts of the invention in a simplified form as a prelude to the more detailed description that is presented later.

Because of these and other problems in the art, there is generally described herein systems and methods for the effective sequestration of waste gases from an industrial process such as, but not limited to, one or more lime or cement kilns used in the production of quicklime. This system may be used in conjunction with one or more shafts to an existing or abandoned mine that includes water capable of removing various pollutants in the gas stream, including but not limited, to sulfur compounds, chlorine compounds, mercury compounds, and carbon dioxide. Such pollutants may be sequestered in the mine itself through the process of particulate formation when the gas stream reacts with the mine water.

There is described herein, among other things, a system and related method for sequestering pollutants in a mine, the system comprising: an open mine space including a body of water which is alkaline in nature; a source of pollutants; an exhaust shaft directing pollutants including a first amount of carbon dioxide (CO₂) from the source of pollutants to the open mine space; and an exit shaft for venting gas from the open mine space; wherein, the first amount of carbon dioxide reacts with the body of water while in the open mine space to reduce the first amount of carbon dioxide to a second amount of carbon dioxide; and wherein, the second amount of carbon dioxide is vented via the exit shaft.

In an embodiment of the system, the open mine space comprises an unused space in a limestone mine.

In an embodiment of the system, the limestone mine is abandoned.

In an embodiment of the system, the limestone mine is still in operation.

In an embodiment of the system, the body of water comprises a seepage pond.

In an embodiment of the system, the body of water is alkaline in nature due to the inclusion of calcium carbonate and/or calcium oxide in the body of water.

In an embodiment of the system, at least some of the calcium carbonate and/or calcium oxide in the body of water occurs naturally.

In an embodiment of the system, at least some of the calcium carbonate and/or calcium oxide in the body of water is purposefully added.

In an embodiment of the system, at least some of the calcium carbonate and/or calcium oxide in the body of water is included in the pollutants.

In an embodiment of the system, the pollutants include calcium carbonate.

In an embodiment of the system, the pollutants include calcium oxide.

In an embodiment of the system, the source of pollutants includes a lime kiln.

In an embodiment of the system, the source of pollutants includes combustion of a fuel.

In an embodiment of the system, the fuel includes a fossil fuel.

In an embodiment of the system, the second amount of carbon dioxide is zero.

In an embodiment of the system, the source of pollutants is collocated with the open mine space.

In an embodiment of the system, the open mine space is underground and the body of water is subterranean.

In an embodiment of the system, the open mine space is open to Earth's atmosphere.

In an embodiment of the system, the exhaust shaft directs the pollutants into the body of water.

In an embodiment, the system further includes water injectors for spraying alkaline water from the body of water in the open mine space.

### BRIEF DESCRIPTION OF THE DRAWINGS

FIG. 1 depicts an embodiment of a system and a method for sequestering carbon dioxide and other pollutants in a mine, specifically in a mine having a source of high pH, alkaline water that may be sprayed into an exhaust gas stream.

FIG. 2 depicts an embodiment of a system and a method for sequestering carbon dioxide and other pollutants in a mine, specifically in a mine having a source of high pH, alkaline water into which an exhaust gas stream may be fed.

### DETAILED DESCRIPTION OF PREFERRED EMBODIMENTS

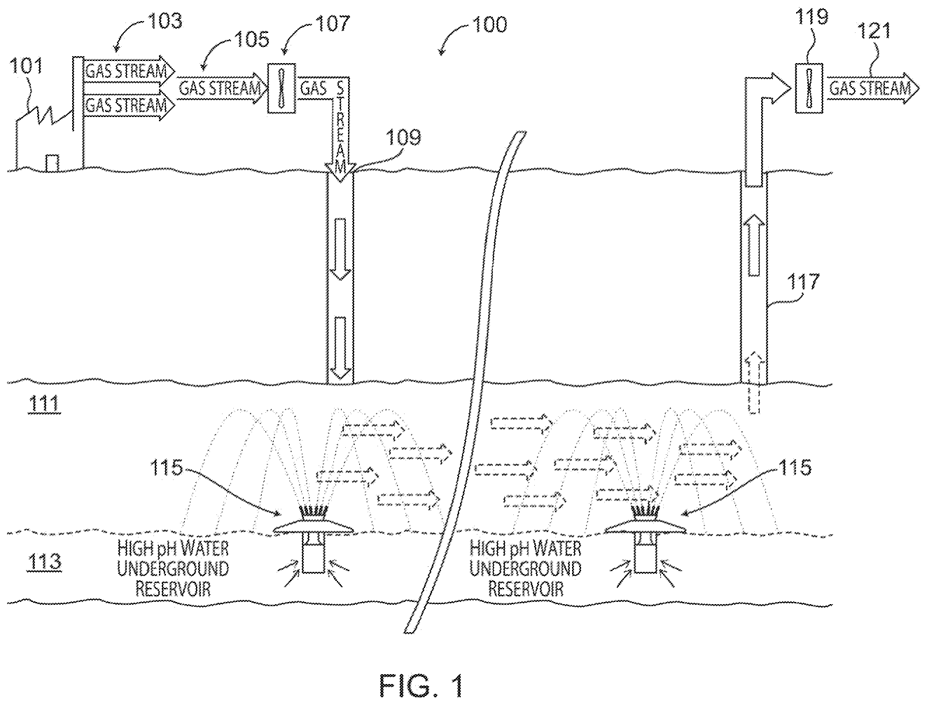

FIG. 1 provides an embodiment of a system (100) for sequestering pollutions in a mine, and particularly in mine water, may work. In the embodiment of the system (100) depicted in FIG. 1, a plant (101) including one or more kilns (not depicted) may be provided. The plant (101) may be any building housing the one or more kilns. The plant (101) may be located proximate to a mine, which mine may be used to gather raw materials for the kiln(s). However, such a proximity to a mine should not be considered to be limiting, as some embodiments of the system (100) will not include the plant (101) being proximate to a mine.

Generally, any number of kilns may be provided in the plant (101). For example, in an embodiment, two or more kilns are provided in the plant (100). The size and shape of each kiln may vary, but in any case, such kilns will typically be industrial in their form. Further, any style or design of kiln may be used. Such kilns may be fired by fossil fuels, for example, coal, petroleum, coke, or oil and/or any other fuel material such as wood or other combustible. A byproduct of firing the kilns, and of the process of making quicklime therein, may be carbon dioxide. Other processes may also create other or additional exhaust gases. In each embodiment, an exhaust gas (103), regardless of how the gas was produced, is a waste product and requires or would benefit from a controlled disposal.

The gas (103) from the multiple kilns (or other sources including without limitation a firing process) may be gathered into a common header duct, resulting in a stream of kiln gas (105), also known as exhaust gas. The stream of kiln gas (105) may then be directed to a fan (107), which fan (107) may provide additional pressure for the stream of kiln gas (105). The fan (107) may be industrial in its construction, design, and/or application. Further, the fan (107) may be any number of fans. In some embodiments, any number of exhaust gas streams (105) may be combined at the common header duct. For example, in some embodiments, only a single exhaust gas stream (103) may enter into the common header duct. In other embodiments, two or more exhaust gas streams (103) may enter into the common header duct such as from multiple kilns and/or multiple processes. In some embodiment, the fan (107) may be omitted. In other embodiments, some other means of increasing pressure and/or particle velocity may be used in place of the fan (107).

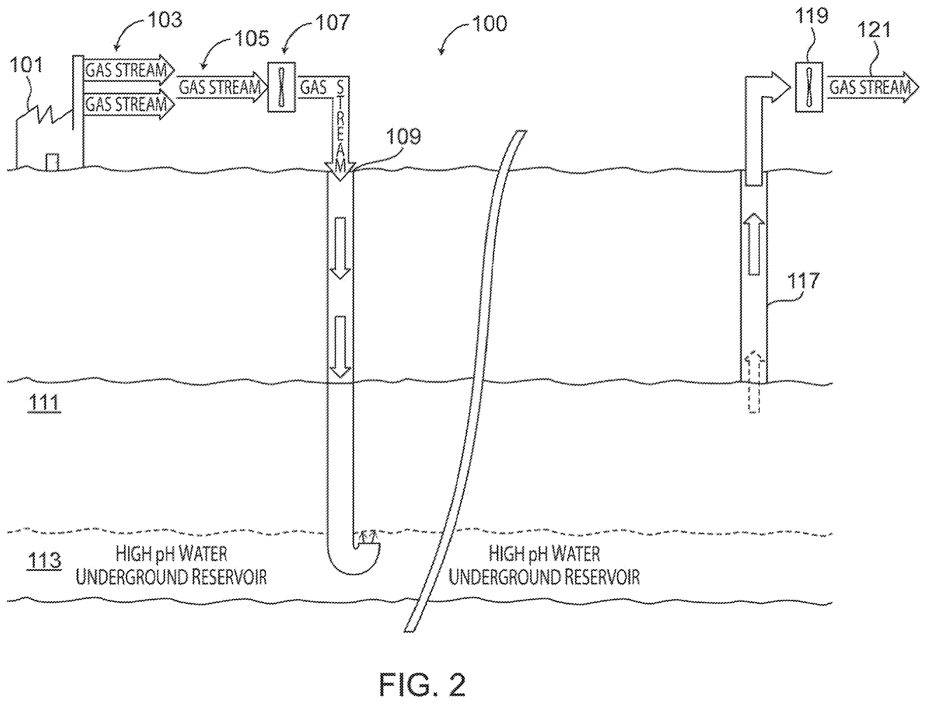

In the depicted embodiment of FIGS. 1 and 2, the stream of kiln gas (105) under this additional pressure may then be forced through an exhaust shaft (109) formed within the ground surrounding the plant (101). Although the embodiment depicted in FIG. 1 shows only a single exhaust shaft (109), more exhaust shafts (109) may be provided. Further, the exhaust shaft (109) may be formed into any size, shape, or orientation, and the exhaust shaft (109) may have any design known to a person of ordinary skill in the art. Moreover, the exhaust shaft (109) may be fabricated from any material (or a compound of materials) that is capable of serving as a conduit for the kiln gas stream (105). For example, in some embodiments, the exhaust shaft (109) may be angled with respect to a vertical plane. Further, in some embodiments, the exhaust shaft (109) may not be linearly formed and may include any number of bends or joints. Moreover, in some embodiments, the cross-section of the exhaust shaft (109) may vary in shape, size, orientation, or in any other variable. Further, the exhaust shaft (109) need not be bored into the ground towards a position that is deeper than the plant (101). For example, in some embodiments, a related open mine space (111) to which the exhaust shaft (109) leads may be formed into a ground mass that is at the same level as, or higher than, the plant (101). In such an embodiment, the open mine space (111) may be formed into a mountain, hill, or other position of greater altitude. Alternately, the plant (101) may be formed in a depression, valley, or other position of lower altitude. Further, in such a case, the exhaust shaft (109) may not travel though the ground, and in some embodiments, may travel above the ground.

In the embodiments depicted in FIGS. 1 and 2, the depicted exhaust shaft (109) opens at one end into the open mine space (111). The open mine space (11) may be any space within a related mine. In some embodiments, the open mine space (111) will be formed in a limestone mine. However, any mine or other underground space may be used. Alternatively, the open mine space (111) may be from a surface or strip mine and thus not underground but on the surface of the Earth. The open mine space (111) may be formed in currently unused portions of the mine. Other portions of the mine may be currently used, or the entire mine may be unused. The open mine space (111) may be manmade or naturally occurring. Typically, the open mine space (111) will be a previously mined portion of a mine which is no longer being used. The mine including the open mine space (111) may have been abandoned (no longer in use) or other portions of the mine including the open mine space (111) may still be in use. Further, the open mine space (111) will typically include a body of water (113). The body of water (113) may be subterranean if the open mine space (111) is underground, or may comprise surface water if the open mine space (111) is not.

In other embodiments, the body of water (113) may be any body or source of water. Further, the body of water (113) may be in any location, including above ground or at ground level. Accordingly, in some embodiments, the body of water (113) may not be formed in a mine. For example, the body of water (113) may be a ground level lake or pond proximate to the plant (101), or may be a lake formed within a quarry or similar manmade (or other) depression. Typically, the body of water (113) will be alkaline, and such alkalinity will be enhanced or maintained when necessary by the addition of calcium carbonate or calcium oxide. Such calcium carbonate or calcium oxide (or other alkaline materials) may be present in the dry waste produced by a related lime kiln, which dry waste may be added to the body of water (113) to create or maintain alkalinity. Such alkalinity may enhance the efficiency of any related carbon dioxide capture. It should be recognized that in one embodiment, the alkaline material added to the water may be carried within the kiln gas stream as another waste product from the same kiln operation via the exhaust shaft (109).

In any embodiment, the body of water (113) may have a different or additional purpose other than use as contemplated in this application for reducing pollutant emissions from a plant (101). In some embodiments, however, it may be particularly useful to use a body of water (113) found in a mine. For example, the use of an open mine space (111) may be useful where it is known that there will be relatively few individuals ever present near the body of water (113). Further, when the body of water (113) is located in a limestone mine, it may be relatively easy and efficient to maintain a water supply to the body of water (113) that is alkaline, which, as discussed below, may be useful in assisting with the removal of pollutants from any stream of kiln gas (105). Further, such locations typically are not useful to human operations or natural animal habitats. Further, in the event that such an area does hoes particular animals, they are usually adapted to survive in conjunction with alkaline water. Additionally, where the mine is located near to the plant (101), it may be most efficient to use the mine due to the close proximity of the mine.

In the embodiments depicted in FIGS. 1 and 2, the body of water (113) will typically be a lake or other pooling of water and is typically considered relatively static. However, the body of water (113) may be a flowing water stream or similar structure. The body of water (113) may have any size, shape, and orientation. In some embodiments, the body of water will be, in whole or in part, a spring or other replenishing water source but this is not required. Replenishing of the body of water (113) may occur through any natural method, e.g. through seepage or precipitation, may not occur at all as the body of water (113) effectively exists inside a closed system, or may occur through any human activity which replenishes it.

The body of water (113) itself will typically be naturally alkaline in nature, which typically entails the water itself being at least slightly basic (typically having a pH between about 7.1 and about 10.0). In some embodiments, the dissolution of limestone or other source of calcium carbonate and/or calcium oxide may contribute to the alkalinity of the body of water (113). For example, water may seep through limestone deposits on the way to reaching the body of water (113). The alkalinity of the water may also or alternatively be enhanced or maintained by the addition of calcium carbonate or calcium oxide. Such calcium carbonate or calcium oxide (or other alkaline materials) may be present in the dry waste produced by a related lime kiln, which dry waste may be added to the water to create or maintain alkalinity.

These additions may be used to maintain or increase the alkalinity of the body of water (113) by periodically depositing alkaline kiln scrubber sludge, which is the dust from the exhaust of a lime kiln (such as exhaust gas streams (103)) that is commonly collected in the industry by exhaust gas filters, in the body of water (113) or by allowing such dust to be transported by the exhaust stream to be treated. In other embodiments, any method known to persons of ordinary skill in the art for maintaining a body of water's alkalinity may be used. For example, such alkalinity may be enhanced or maintained when necessary by the addition of calcium carbonate or calcium oxide. Such calcium carbonate or calcium oxide (or other alkaline materials) may be present in the dry waste produced by a related lime kiln, which dry waste may be added to the body of water (113) to create or maintain alkalinity.

The alkaline nature of the body of water (113) is believed useful in sequestering carbon dioxide from the streams of kiln gas (105). This may be due to carbon dioxide's ability to form an acid (for example, carbonic acid) when dissolved into water. The alkaline water, and the ions therein, may then react with the acid, forming various carbonates and/or bicarbonates, which will typically precipitate into the body of water (113). In a typical limestone mine example, the precipitates will tend to be calcium carbonate and calcium bicarbonate. Accordingly, while any water may be used as contemplated herein, increased alkalinity of the water may tend to increase the ability of the body of water (113) to sequester carbon dioxide.

Proximate to the body of water (113) may be one or more water injectors (115). In the embodiment depicted in FIG. 1, a plurality of water injectors (115) is placed into the body of water (113). These water injectors (115) may spray, or inject, the water from the body of water (113) into the air within the open mine space (11) above the body of water (113). In particular, the water injectors (115) may spray, or inject, the water from the water source (113) into the kiln gas stream (105) that has been forced into the open mine space (111) through the exhaust shaft (109).

In some embodiments, the water injectors (115) may be placed outside of the body of water (113), and in such a case, the water injectors (115) may be in communication (via a pipe or other conduit) with the body of water (113). The typically high pH, alkaline water from the body of water (113) may react with the kiln gas stream (105), which may cause material and pollutants in the kiln gas stream (105) to fall out of the kiln gas stream (105), as discussed above. For example, at least some of the carbon dioxide within the kiln gas stream (105) may react with the typically high pH, alkaline water from the body of water (113) to form precipitated calcium carbonate and other materials. Generally, such a precipitation process acts to reduce the amounts of carbon dioxide and other pollutants introduced into the environment as a result of operating a lime kiln.

Any remains of the kiln gas stream (105), as well as any air in the open mine space (111) that is displaced by kiln gas stream (105), may exit the open mine space (111) at an exit shaft (117). Similar to the exhaust shaft (109), although the embodiment depicted in FIG. 1 shows only a single exit shaft (117), more exit shafts (117) may be provided. Further, the exit shaft (117) may be formed into any size, shape, or orientation, and the exit shat (117) may have any design known to a person of ordinary skill in the art. For example, in some embodiments, the exit shaft (117) may be angled with respect to a vertical plane. In some embodiments, the exit shaft (117) may not be linearly formed and may include any number of bends or joints.

Moreover, the exit shaft (117) may be fabricated from any material (or a compound of materials) that is capable of serving as a conduit for the exiting gas. In some embodiments, the cross-section of the exit shaft (117) may vary in shape, size, orientation, or in any other variable. Further, the exit shaft (117) need not be bored into the ground towards a position that is above or higher than the open mine space (11). For example, in some embodiments, the open mine space (111) may be on the same level as, or even above, where the exit shaft (117) is to be routed. In such an embodiment, the open mine space (111) may be formed into a mountain, hill, or other position of greater altitude than where the exit shaft (111) is to be routed. Alternately, the place where the exit shaft (117) is to be routed may be in a depression, valley, or other position of lower altitude. Typically, the place where the exit shaft (117) is to be routed will be open to the atmosphere. In other embodiments, no exit shaft (117) may be provided. In such a case, the stream of kiln gas (105) may remain in the mine or otherwise be distributed from the mine by some alternate opening. In a still further embodiment, the body of water (113) may be external or otherwise be open to the atmosphere without the need for an exhaust shaft.

The remains of the stream of kiln gas (105), as well as any air in the open mine space (111) that is displaced by the stream of kiln gas (105), may be pulled from the open mine space (111) using an exit fan (119). The material and gas that is pulled from the open mine space (111) may be a carbon reduced gas stream (121). The carbon reduced gas stream (121) may have less carbon dioxide as a constituent than the stream of kiln gas (105). Further, the carbon reduced gas stream (121) may have less other pollutants as constituents than the stream of kiln gas (105).

In an alternative embodiment depicted in FIG. 2, the exhaust shaft (109) may be extended to under the surface of the pooling body of water (113). This may allow the stream of kiln gas (105) to be directly feed, or injected, into the typically high pH, alkaline water from the body of water (113). The stream of kiln gas (105) may be injected into the body of water (113) using any method known to a person of ordinary skill in the art. For example, in an embodiment, an open end of the exhaust shaft (109) is located below the surface of the body of water (113). In another embodiment, as is depicted in FIG. 2, the exhaust shaft (109) may include a rounded portion formed under the surface of the body of water (113), allowing for the introduction of the gas stream (105) into the water at a different surface area and volume. In other embodiments, the exhaust shaft (109) may include a portion that extends under the surface of the body of water (113) that is permeated with smaller holes, allowing the kiln gas stream (105) to bubble out of that portion of the exhaust shaft (109).

In an alternative embodiment, the system (100) may incorporate both the exhaust shaft (109) being extended to under the surface of the body of water (113) depicted in FIG. 2 and the water injectors (115) depicted in FIG. 1. In all of the above embodiments, the body of water (113), and in some cases the enclosure of the body of water, may, thus, be incorporated in the exhaust pathway or ducting of the exhaust gas stream (105). This can result in an elimination or reduction of vertical ducting and/or traditional smokestacks.

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

It will further be understood that any of the ranges, values, properties, or characteristics given for any single component of the present disclosure can be used interchangeably with any ranges, values, properties, or characteristics given for any of the other components of the disclosure, where compatible, to form an embodiment having defined values for each of the components, as given herein throughout. Further, ranges provided for a genus or a category can also be applied to species within the genus or members of the category unless otherwise noted.

Finally, the qualifier “generally,” and similar qualifiers as used in the present case, would be understood by one of ordinary skill in the art to accommodate recognizable attempts to conform a device to the qualified term, which may nevertheless fall short of doing so. This is because terms such as “cylindrical” are purely geometric constructs and no real-world component is a true “cylindrical” in the geometric sense. Variations from geometric and mathematical descriptions are unavoidable due to, among other things, manufacturing tolerances resulting in shape variations, defects and imperfections, non-uniform thermal expansion, and natural wear. Moreover, there exists for every object a level of magnification at which geometric and mathematical descriptors fail due to the nature of matter. One of ordinary skill would thus understand the term “generally” and relationships contemplated herein regardless of the inclusion of such qualifiers to include a range of variations from the literal geometric meaning of the term in view of these and other considerations.

1. A system for sequestering pollutants in a mine, the system comprising:
an open mine space including a body of water which is alkaline in nature;
a source of pollutants;
an exhaust shaft directing pollutants including a first amount of carbon dioxide (CO₂) from said source of pollutants to said open mine space; and
an exit shaft for venting gas from said open mine space;
wherein, said first amount of carbon dioxide reacts with said body of water while in said open mine space to reduce said first amount of carbon dioxide to a second amount of carbon dioxide; and
wherein, said second amount of carbon dioxide is vented via said exit shaft.

2. The system of claim 1, wherein said open mine space comprises an unused space in a limestone mine.

3. The system of claim 2, wherein said limestone mine is abandoned.

4. The system of claim 2, wherein said limestone mine is still in operation.

5. The system of claim 1, wherein said body of water comprises a seepage pond.

6. The system of claim 1, wherein said body of water is alkaline in nature due to the inclusion of calcium carbonate and/or calcium oxide in said body of water.

7. The system of claim 6, wherein at least some of said calcium carbonate and/or calcium oxide in said body of water occurs naturally.

8. The system of claim 6, wherein at least some of said calcium carbonate and/or calcium oxide in said body of water is purposefully added.

9. The system of claim 6, wherein at least some of said calcium carbonate and/or calcium oxide in said body of water is included in said pollutants.

10. The system of claim 1, wherein said pollutants include calcium carbonate.

11. The system of claim 1, wherein said pollutants include calcium oxide.

12. The system of claim 1, wherein said source of pollutants includes a lime kiln.

13. The system of claim 1, wherein said source of pollutants includes combustion of a fuel.

14. The system of claim 13, wherein said fuel includes a fossil fuel.

15. The system of claim 1, wherein said second amount of carbon dioxide is zero.

16. The system of claim 1, wherein said source of pollutants is collocated with said open mine space.

17. The system of claim 1, wherein said open mine space is underground and said body of water is subterranean.

18. The system of claim 1, wherein said open mine space is open to Earth's atmosphere.

19. The system of claim 1, wherein said exhaust shaft directs said pollutants into said body of water.

20. The system of claim 1 further including water injectors for spraying alkaline water from said body of water in said open mine space.
